(19) United States
(12) Patent Application Publication
(10) Pub. No.: US 2010/0299216 A1
(43) Pub. Date: Nov. 25, 2010

(54) Electronic Commerce Transaction Method and Electronic Commerce Transaction System for Enterprise Network Marketing and Purchase Outsourcing

(76) Inventor: Yong Chen, Fujian (CN)

Correspondence Address: HDLS IPR Services, PO Box 220746, Chantilly, VA, 20153, US

(21) Appl. No.: 12/746,478

(22) PCT Filed: May 16, 2008
(86) PCT No.: PCT/CN2008/071001

§ 371 Date: Jun. 4, 2010

(30) Foreign Application Priority Data
Dec. 6, 2007 (CN) 200710195679.4

(51) Int. Cl. G06Q 30/00

(52) U.S. Cl. 705/14.73; 705/26.3

(57) ABSTRACT

The invention discloses an electronic business method and system for enterprise cyber marketing and procurement outsourcing. The electronic business system includes: an enterprise information publishing system; a professional information publishing system; an authorizing, sending, receiving and managing system for email, network telephone, network fax and instant messaging tool; a bidding system; a B2B information flow subdivision charging system; a mutual evaluation system; and a complaint management system. In particular, the invention can be applied to a B2B electronic business method to overcome limitations of the existing B2B method. The invention is a people-oriented electronic business method and system, a multi-lingual professional online support method that is based on demands and with a low cost. The invention allows an enterprise to outsource its cyber marketing and procurement to multi-lingual professionals anywhere in the world, so that the enterprise can obtain the cyber marketing and procurement service by sharing the services offered by those multi-lingual professionals from anywhere in the world at low labor cost.

### BACKGROUND OF INVENTION

1. Field of the Invention

The invention relates to an Electronic Business Method and System. More particularly, the invention provides an Electronic Business Method and System for Enterprise Cyber Marketing and Procurement Outsourcing, abbreviated as B2P2B electronic business method and system, in which Bs (BUSINESS) refer to either suppliers or buyers, and P (PERSON) refers to professionals. B2P2B means that businesses communicate via external professional.

2. Description of the Related Art

Nowadays, to carry out marketing and procurement, an enterprise usually recruits professional in society, trains them, and at last makes them perform marketing and procurement. There are both traditional marketing and procurement without using the internet, and marketing and procurement that utilize the internet. In particular, marketing and procurement utilizing the internet has been commonly practiced by many enterprises in international trade.

Cyber marketing and procurement requires knowledge about electronic business as well as marketing and procurement. Furthermore, the ability of understanding foreign languages is a must in international trade. Recently, in the era of global business without borders enabled by Internet, multi-lingual professionals are particularly important to do cyber marketing and procurement. However, it is very difficult for an enterprise, especially small or medium sized enterprise, to recruit such multi-lingual cyber marketing and procurement professionals. Even if such professional were recruited, there would still be difficulties in training and managing them. Furthermore, more than two-thirds of the world's population does not use English as their native language, and it is neither affordable nor necessary for most enterprises to recruit so many multi-lingual professionals for cyber marketing and procurement.

The characteristics of the Internet have made it possible for multi-lingual professionals in different places of the world to provide services to enterprises on basis of the Internet. However, due to the characteristics of cyber marketing and procurement as well as trade services, currently it is difficult for an enterprise to outsource its cyber marketing and procurement to external professionals.

The existing B2B method (also referred to as BTOB, Business To Business) means that enterprises communicate among them via Internet. The most typical example is a platform publishing supply and demand information, where suppliers publish information on commodities to sell or services they provide on a website providing the information publishing platform, while buyers publish on the very same website information on commodities or services they need, so that enterprises on the platform can learn about the published information and make responses of interests. Such a traditional B2B method has limitations in the following aspects
1) Lack of rationality and flexibility in charging. The method used by traditional B2B websites usually charge membership fees. The members of selling enterprises would have to pay membership fee from several thousands to tens of thousand RMB regardless of whether or not they have received the purchasing information of buyers or the amount of purchasing information. This method has raised the entry barrier of B2B electronic business for enterprises, especially small and medium sized enterprises.
2) Information island effect, Imbalance between supply and demand. The traditional B2B website method, in particular, the method of supply and demand information publishing platform, is a close information communication method, with a lot of sellers but much fewer buyers. For example, even on the most famous B2B website, the average daily ratio of buying information to selling information is only 0.2%. The present situation results that such kind of B2B website has practically functions as yellow pages of the products or services of suppliers, becoming an isolated island in the information sea.
3) Passive waiting. In the traditional B2B website method, a member just lists its product as well as its sale intention on line and waits for incoming inquiries from buyers on the same platform. On the other hand, potential buyers focusing on domestic market are not keen on search for overseas suppliers. So this passive waiting will lead the suppliers lose majority of the potential customers.
4) Insufficiency of languages. The traditional B2B website method is based on English or other single language version. Even if a multi-lingual version is intended to be built, lack of multi-lingual professionals of members makes it impossible for the multi-lingual version website to act as a platform of information exchange. The number of population speaking English as native language does not rank first in the world, and many businesses prefer their mother languages in communications.
5) Information distortion. In the traditional B2B website method, the buyers have taken a stronger position, and information published by them may be distorted. Even if the information itself is true, usually distortion may be caused due to the inquiry of price by multiple buyers. Under the method of stationary fee charges, the sellers may try their best to attract buyers to make inquiry by listing product information that is not actually real. This has created mutual distrust between sellers and buyers that has an adverse effect on the information communication therebetween.
6) Result of bargaining. In the traditional B2B website method, buyers take a stronger position, and the result caused by inquiry of price by multiple parties has forced sellers to lower their prices, such a price war would sacrifice quality of products and services, which would eventually do harm to the long term benefits of both sides.
7) Lack of individualized and people-oriented sales promotion. In the traditional B2B website method, members list their products in a fixed format and cannot showcase their specialty and excellence. Also, they may be unwilling to release their up-to-date products due to worry of piracy by commercial rivals. This leads to lack of individualization in members' sales promotion; on the other hand, because of shortage of professional, small or medium sized enterprises cannot carry out people-oriented sales promotion, either.

### SUMMARY OF THE INVENTION

Therefore it is an object of the invention to provide an Electronic Business Method and System for Enterprise cyber Marketing and Procurement Outsourcing (referred to as B2P2B electronic business method and system). In particular, the invention can be applied to a B2B electronic business method to overcome limitations of the existing B2B method. The invention is a people-oriented electronic business method and system, and a multi-lingual professional online support method that is based on demands and with a low cost. The invention allows an enterprise to outsource its cyber marketing and procurement to multi-lingual professionals anywhere in the world, so that the enterprise can obtain the cyber marketing and procurement service by sharing the services offered by those multi-lingual professionals from anywhere in the world at low labor cost.

To achieve the above object, the invention provides an Electronic Business Method and System for Enterprise cyber Marketing and Procurement Outsourcing, the Electronic Business System includes:
an enterprise information publishing system used for the enterprise to publish information on products or services;
a professional information publishing system used for the professionals to publish their resumes;
an authorizing, sending, receiving and managing system, when the professionals get authorization from the enterprise, they carry out marketing and procurement by using email address, network telephone, network fax and instant messaging tool of the enterprise, and the enterprise manages the marketing and procurement by using the above mentioned tools;
a bidding system, used for the enterprise and professionals to set a price of information service;
B2B information flow subdivision charging system, used to subdivide the information about the enterprise marketing and procurement to perform quantity calculation and quality inspection, so as to make corresponding billing and payment;
a mutual evaluation system, used for the professionals and the enterprise to make mutual evaluation; and
a complaint management system, used to handle the professionals' or the enterprise's complaint about transactions.

Preferably, the system divides the online marketing and procurement into one or more processes in which the quantity calculation and quality inspection can be performed, so that transaction can be carried out.

Preferably, the enterprise' contact means (email box, network fax, network telephone, instant messaging tool, etc) are integrated into the present electronic business system, so that the outsourcing professionals have access to the contact means and have to use the contact means to carry out the marketing and procurement, but can't possess or dominate the contact means.

The invention also provides an Electronic Business Method for Enterprise cyber Marketing and Procurement Outsourcing, the method includes the steps of:
an enterprise publishing its brief introduction, product information, information about email, network telephone or network fax; marketing professionals publishing their qualifications and resumes, setting a price for their services;
after selection, the enterprise authorizing the professionals to utilize its email box, network fax, network telephone or instant messaging tool to contact and negotiate with potential customers, and making payment in the of B2P2B method service provider;
the content of contact and negotiation conducted by the entrusted professional being stored in a database accessible to the enterprise;
the B2P2B method service provider transferring the payment for the service to the professionals at a specified time after confirming that the enterprise and the professionals have reached an agreement on substance of the contact or negotiation, and if complaints occur, the B2P2B method service provider suspending the transfer of payment for the service, and handling the complaint after an impartial judgment over the transaction;
the enterprise and the professionals performing a mutual evaluation after the transaction therebetween is over, the evaluation result being stored in the database to serve as a reference indicator for other participants in transaction.

The advantageous effect of the above technical solution is as follows: the invention provides an online service method by multi-lingual professionals, which is based on demand and with a low cost. The method can meet the requirements of both sides in B2B, and has resolved the seven problems with the afore-mentioned traditional B2B method. Among other things, it has the following advantages:
1. The transaction under the B2P2B electronic business method and system consists of emails, network faxes or other similar Internet communication tools. The cost of transaction for an email or a network fax may be about 1 RMB, which greatly reduce the threshold of carrying out electronic business for the Bs (either suppliers or buyers). The Bs can set its cost for marketing and procurement according to their needs.
2. The B2P2B electronic business method and system are an open cyber marketing and procurement method and system, which differ from the traditional close B2B method and system. The professionals carrying out the marketing and procurement can use their ability to contact potential customers over Internet or other media. Hence, the present method and system can avoid the adverse effect caused by imbalance between supply and demand.
3. The B2P2B electronic business method and system are completely proactive in marketing and procurement. The professionals start marketing and procurement over Internet immediately right after being commissioned.
4. The professionals serving in the B2P2B electronic business method and system are ones mastering a plurality of different languages. The service with most languages in the world can be provided in the B2P2B electronic business method and system.
5. The demand-based charging method in the B2P2B electronic business method and system forces the Bs to make a precise to marketing and procurement commission.
6. The B2P2B electronic business method and system also allows one-to-one business inquiry and negotiation, which avoids too low price caused by aggregation of suppliers.
7. In the B2P2B electronic business method and system, the Bs showcase their individualized directory of various kinds of products and their strengths. The Bs can also duly release their up-to-date products privately in communications. By way of the evaluation and incentive system, the B2P2B electronic business method and system selects the multi-lingual professionals skilled in cyber marketing and procurement, who can help the Bs to carry out people-oriented marketing and procurement. Through the professionals-sharing mechanism introduced under the B2P2B electronic business method and system, the Bs don't need to worry about the training and drain of marketing and procurement professionals any more.

The benefits of the invention also lie in that:
1. Providing thorough professional resources for enterprise marketing and procurement skilled in multiple languages. The enterprises, especially small and medium sized enterprises, are short of marketing and procurement professionals with multi-lingual abilities, and even large enterprises are also short of marketing and procurement professionals with multi-lingual abilities. The B2P2B electronic business method and system provided in the invention can greatly reduce the labor cost spent on foreign language professionals by the enterprises, and enable the enterprises to outsource their foreign trade marketing and procurement.
2. Providing job opportunities. The present B2P2B electronic business method and system enables the marketing and procurement professionals with multi-lingual abilities to utilize the 7/24 availability and non-bordered feature of Internet to exploit more income sources.
3. Providing a reasonable allocation means for the worldwide marketing and procurement professional resources. Human resource outsourcing is a worldwide trend, while the present B2P2B electronic business method and system can make use of professional intelligence beyond the limit of national borders, average the worldwide labor cost, realize the precise marketing and people-oriented marketing of the enterprises, and avoid the junk email nuisance caused by the aimless software-based marketing and procurement in the existing cyber marketing and procurement activities of the enterprises. As a result, all of the three parties, i.e., the society, the enterprises and the professionals, will be benefited.

### BRIEF DESCRIPTION OF THE DRAWINGS

The invention will be further explained below with reference to the accompanying drawings, in which:

FIG. 1 is a systematic flow chart of publishing information and setting price by the Bs and the Ps (marketing and procurement professionals) according to the invention;

FIG. 2 is a systematic flow chart of the transaction and service of contacting potential customers between the Bs and the Ps according to the invention;

FIG. 3 is a systematic flow chart of the transaction and service of negotiating with customers between the Bs and the Ps according to the invention;

FIG. 4 is a diagram illustrating the relationship among respective participants according to the invention; and

FIG. 5 is a flow chart of the invention.

### DETAILED DESCRIPTION OF THE EMBODIMENTS

It is desired to realize an Electronic Business Method and system for enterprises to make cyber marketing and procurement outsourcing (“B2P2B electronic business method and system”), which will be illustrated in details hereafter:

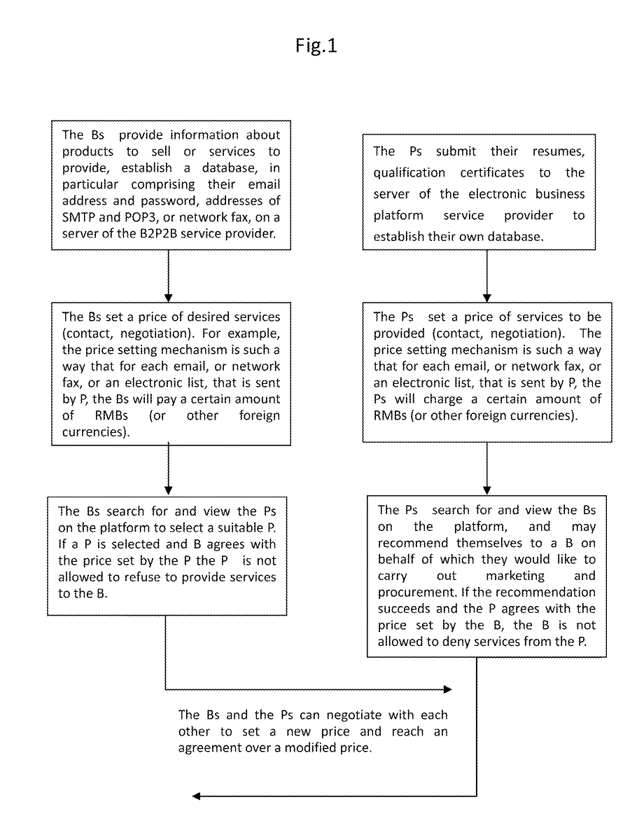

As shown in FIG. 1, the invention provides an information publishing and price setting systematic module for the Bs and the Ps(marketing and procurement professionals), which includes:
Step 1. The Bs provide information about products to sell or services to provide, establish a database, in particular comprising their email address and password, addresses of SMTP and POP3, or network fax, on a server of the B2P2B service provider. The Ps submit their resumes, qualification certificates to the server of the electronic business platform service provider to establish their own database.
Step 2. The Bs set a price of desired services (contact, negotiation). For example, the price setting mechanism is such a way that for each email, or network fax, or an electronic list, that is sent by P, the Bs will pay a certain amount of RMBs (or other foreign currencies). Alternatively, the price setting mechanism may be such a way that the Bs will pay a certain ratio of the amount of money obtained by selling a volume of products.(commission method). The Ps set a price of services to be provided (contact, negotiation). The price setting mechanism is such a way that for each email, or network fax, or an electronic list, that is sent by P, the Ps will charge a certain amount of RMBs (or other foreign currencies). Alternatively, the price setting mechanism may be such a way that the Bs will pay a certain ratio of the amount of money obtained by selling a volume of products.(commission method).
Step 3. The Bs search for and view the Ps on the platform to select a suitable P (marketing and procurement professional). If a P is selected and B agrees with the price set by the P (marketing and procurement professional) the P (marketing and procurement professional) is not allowed to refuse to provide services to the B. On the other hand, the Ps search for and view the Bs on the platform, and may recommend themselves to a B (either a supplier or a buyer) on behalf of which they would like to carry out marketing and procurement. If the recommendation succeeds and the P agrees with the price set by the B (either a supplier or a buyer), the B (either a supplier or a buyer) is not allowed to deny services from the P. Alternatively, the Bs and the Ps can negotiate with each other to set a new price and reach an agreement over a modified price.

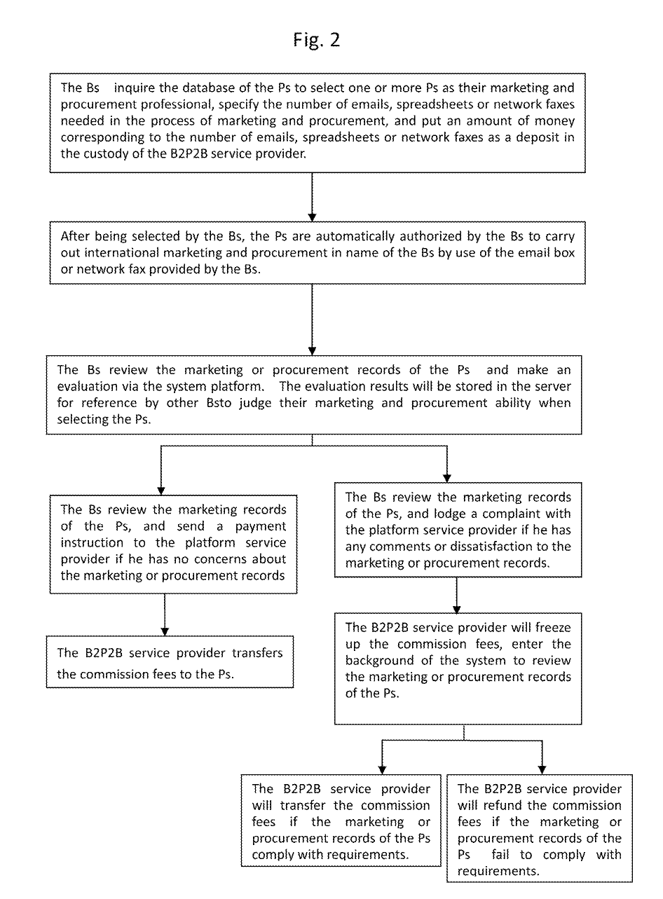

As illustrated in FIG. 2, the invention provides a module of transaction and service of contacting potential customers between the Bs and the Ps (marketing and procurement professionals), which includes:
Step 4. The Bs inquire the database of the Ps to select one or more Ps as their marketing and procurement professional, specify the number of emails, spreadsheets or network faxes needed in the process of marketing and procurement, and put an amount of money corresponding to the number of emails, spreadsheets or network faxes as a deposit in the custody of the B2P2B service provider. If the commission method is employed, then the enterprises should put a promised deposit in the custody of the B2P2B service provider.
Step 5. The Bs review the marketing or procurement records of the Ps and make an evaluation via the system platform. The evaluation results will be stored in the server for reference by other Bs to judge their marketing and procurement ability when selecting the Ps (marketing and procurement professionals).
Step 6. The Bs review the marketing records of the Ps (marketing and procurement professionals), and send a payment instruction to the platform service provider if he has no concerns about the marketing or procurement records; alternatively, the Bs review the marketing records of the Ps (marketing and procurement professionals), and lodge a complaint with the platform service provider if he has any comments or dissatisfaction to the marketing or procurement records.
Step 7. The B2P2B service provider transfers the commission fees to the Ps (marketing and procurement professionals). In case of a complaint occurs, the B2P2B service provider will freeze up the commission fees, enter the background of the system to review the marketing or procurement records of the Ps (marketing and procurement professionals), and proceed to Step 8.
Step 8. The B2P2B service provider will transfer the commission fees if the marketing or procurement records of the Ps comply with requirements. The B2P2B service provider will refund the commission fees if the marketing or procurement records of the Ps fail to comply with requirements.

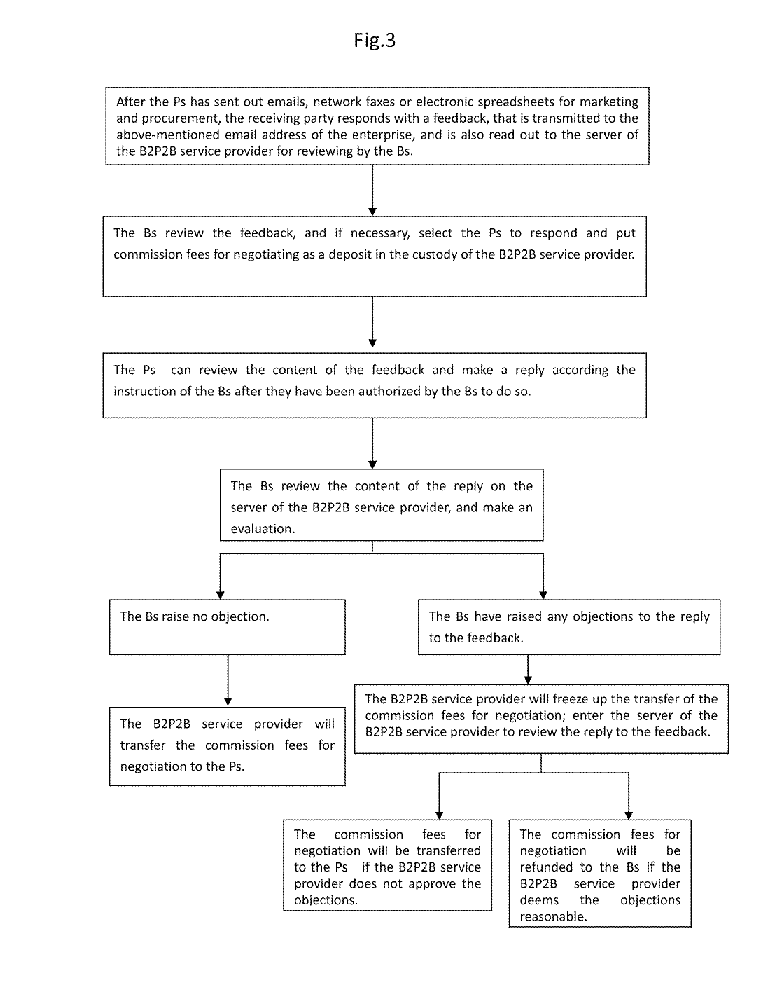

As illustrated in FIG. 3, the invention provides a module of transaction and service of negotiating with customers between the Bs and the Ps (marketing and procurement professionals), which includes:
Step 9. After the Ps has sent out emails, network faxes or electronic spreadsheets for marketing and procurement, the receiving party responds with a feedback, that is transmitted to the above-mentioned email address of the enterprise, and is also read out to the server of the B2P2B service provider for reviewing by the Bs.
Step 10. The Bs review the feedback, and if necessary, select the Ps to respond (negotiate) and put commission fees for negotiating as a deposit in the custody of the B2P2B service provider.
Step 11. The Ps can review the content of the feedback and make a reply according the instruction of the Bs after they have been authorized by the Bs to do so.
Step 12. The Bs review the content of the reply on the server of the B2P2B service provider, and make an evaluation.
Step 13. The B2P2B service provider will transfer the commission fees for negotiation to the Ps if the Bs raise no objection within a certain time period. Alternatively, in case that the Bs have raised any objections to the reply to the feedback, the B2P2B service provider will freeze up the transfer of the commission fees for negotiation; enter the server of the B2P2B service provider to review the reply to the feedback, and then proceed to Step 14.
Step 14. The commission fees for negotiation will be transferred to the Ps if the B2P2B service provider does not approve the objections. The commission fees for negotiation will be refunded to the Bs if the B2P2B service provider deems the objections reasonable

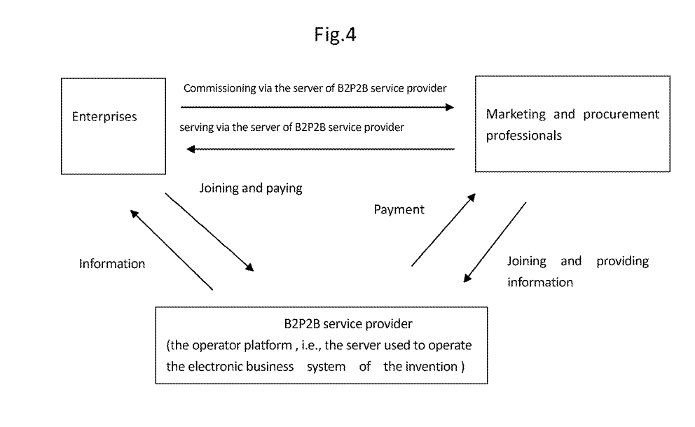

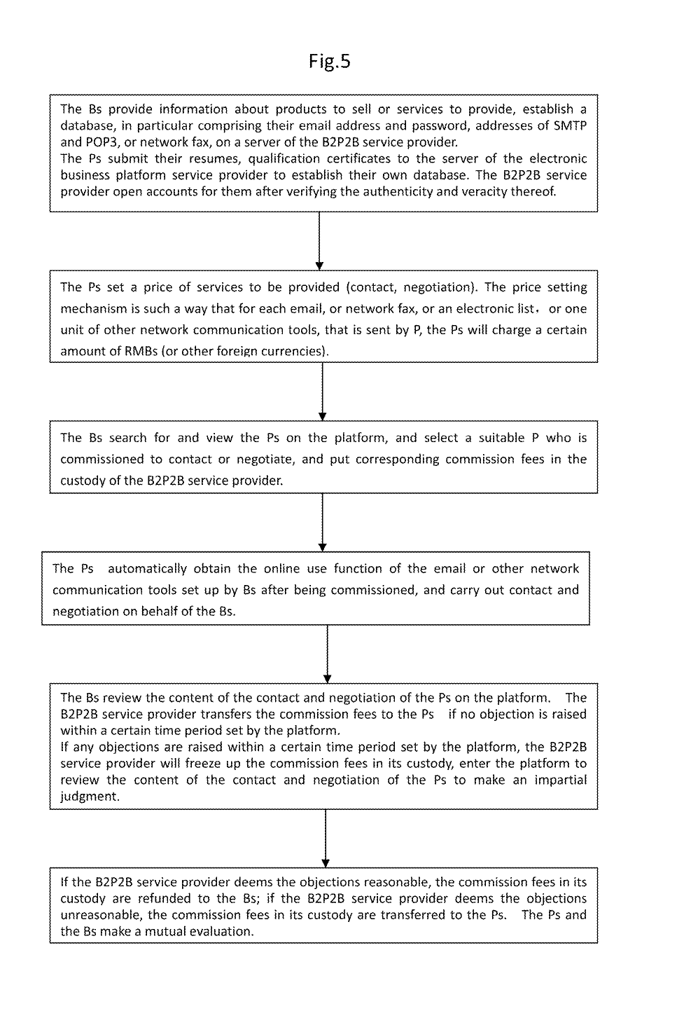

Please refer to FIGS. 4 and 5 which depict the relationship among respective participants and the overall flow of the system respectively to understand the invention further.

What has been described above is merely the currently preferred embodiments of the invention, and is not intended to limit the scope of the invention.

What is claimed is:

1. An electronic business system for enterprise to do cyber marketing and procurement outsourcing, the system comprising:
an enterprise information publishing system, used for enterprises to publish information about products or services to sell or provide;
a professional information publishing system, used for professional(s) to publish their resumes;
an authorizing, sending, receiving and managing system, used for authorizing the use of email, network telephone, network fax and instant messaging tool, wherein after being authorized by the enterprises the professional(s) utilize the enterprise's email, network telephone, network fax or instant messaging tool to carry out marketing and procurement, the enterprise manages the professionals' marketing and procurement;
a bidding system, used for the professional(s) and the enterprise to set a price of information service;
a B2B information flow subdivision charging system, by which the information about enterprises' marketing and procurement is subdivided to perform quantity calculation and quality inspection and to make corresponding billing and payment;
a mutual evaluation system, used the professional(s) and the enterprises to make a mutual evaluation; and
a complaint management system, used to handle the professionals' or the enterprises' complaint about the transaction therebetween.

2. The system according to claim 1, wherein the online marketing and procurement are divided into one or more processes in which quantity calculation and quality inspection can be performed, so as to allow the transaction to be carried out.

3. The system according to claim 1, wherein the enterprise' contact means, such as email box, network fax, network telephone, instant messaging tool, etc, are integrated into the electronic business system, so that the outsourcing professional(s) may have an access to the contact means and have to use it to carry out the marketing and procurement, but don't own and dominate the contact means.

4. An Electronic Business Method for Enterprise cyber Marketing and Procurement Outsourcing, the method comprising:
an enterprise publishing enterprise introduction, product information, and information about email, network telephone or network fax;
marketing professional(s) publishing their qualification and resumes, setting a price for their services;
after selecting professional(s), the enterprise authorizing the professional(s) to utilize its email box, network fax, network telephone or instant messaging tool to contact and negotiate with potential customers, and putting service payment in the custody of a B2P2B method service provider;
the content of contact and negotiation conducted by the professional(s) being stored in a database accessible to the enterprise;
the B2P2B method service provider transferring the payment for the services to the professional(s) at a specified time after confirming that the enterprise is satisfied with the content of the contact or negotiation conducted by the professional(s), and in case of a complaint occurs, the B2P2B method service provider freezing up the transfer of payment for the service, and handling the complaint after an impartial judgment over the transaction;
the enterprise and the professional(s) performing a mutual evaluation after the transaction therebetween is over, the evaluation results being stored in the database to serve as a reference indicator for other participants in transaction.
